(19) United States
(12) Patent Application Publication
(10) Pub. No.: US 2022/0261784 A1
(43) Pub. Date: Aug. 18, 2022

(54) SYSTEMS AND METHODS FOR DETERMINING PAYMENT CARD PROVISIONING AVAILABILITY IN MOBILE APPLICATIONS

(71) Applicant: JPMORGAN CHASE BANK, N.A., New York, NY (US)

(72) Inventors: Sridhar ARAVAMUDHAN, Middletown, DE (US); Tharakesh RANGASWAMY, Frisco, TX (US); Sudha RAMANATHAN, New York, NY (US); Peter Francis LOURDUSAMY, New York, NY (US); Narender GATTINENI, New York, NY (US); Maqbul HUSSAIN, New York, NY (US); Ravi KATTAMURI, New York, NY (US); Raghuram VUDATHU, Downingtown, PA (US); Jon ROSNER, White Plains, NY (US); Shruti PATEL, New York, NY (US)

(21) Appl. No.: 17/651,517

(22) Filed: Feb. 17, 2022

Related U.S. Application Data
(60) Provisional application No. 63/151,014, filed on Feb. 18, 2021.

(51) Int. Cl. G06Q 20/22; G06Q 20/10; G06Q 20/06; G06Q 20/32; G06Q 20/40

(52) U.S. Cl. CPC G06Q 20/227; G06Q 20/105; G06Q 20/4014; G06Q 20/326; G06Q 20/065

(57) ABSTRACT

A method for determining payment card provisioning availability may include an electronic wallet application executed by an electronic device: retrieving a profile identifier from memory; calling an issuing financial institution with the profile identifier for a number of eligible payment cards associated with the profile identifier; receiving the number of eligible payment cards associated with the profile identifier from the issuing financial institution; calling a provider for the electronic wallet application for a number of eligible payment cards that are already provisioned to the electronic wallet application; receiving the number of eligible payment cards that are already provisioned to the electronic wallet application; determining that the number of eligible payment cards is greater than the number of eligible payment cards that are already provisioned to the electronic wallet application; and displaying an option to add a payment card to a payment card to the electronic wallet application.

### RELATED APPLICATIONS

This application claims priority to, and the benefit of, U.S. Provisional Patent Application Ser. No. 63/151,014, filed Feb. 18, 2021, the disclosure of which is hereby incorporated, by reference, in its entirety.

### BACKGROUND OF THE INVENTION

### 1. Field of the Invention

Embodiments generally relate to systems and methods for determining payment card provisioning availability in mobile applications.

### 2. Description of the Related Art

Mobile applications on electronic devices are able to determine if another application is loaded on the same device. Despite this ability, that may not be enough to determine if the applications should be linked in a business meaningful way.

### SUMMARY OF THE INVENTION

Systems and methods for determining payment card provisioning availability in mobile applications are disclosed. In one embodiment, a method for determining card availability may include: (1) retrieving, by an electronic wallet application executed by an electronic device, a profile identifier from a memory of the electronic device; (2) calling, by the electronic wallet application, an issuing financial institution with the profile identifier for a number of eligible payment cards associated with the profile identifier; (3) receiving, by the electronic wallet application, the number of eligible payment cards associated with the profile identifier from the issuing financial institution; (4) calling, by the electronic wallet application, a provider for the electronic wallet application for a number of eligible payment cards that are already provisioned to the electronic wallet application; (5) receiving, by the electronic wallet application, the number of eligible payment cards that are already provisioned to the electronic wallet application; (6) determining, by the electronic wallet application, that the number of eligible payment cards is greater than the number of eligible payment cards that are already provisioned to the electronic wallet application; and (7) displaying, by the electronic wallet application, an icon indicating an option to add a payment card to a payment card to the electronic wallet application.

In one embodiment, the profile identifier may be encrypted.

In one embodiment, the call to the issuing financial institution may include a call to a database of profile identifiers, each profile identifier mapped to a number of eligible payment cards. The database may be provided at an edge of network for the issuing financial institution.

In one embodiment, the electronic wallet application may use an application extension for an issuing financial institution application that extends functionality of the issuing financial institution application to the electronic wallet application to retrieve the profile identifier from a memory of the electronic device and to call the issuing financial institution with the profile identifier for the number of eligible payment cards associated with the profile identifier. The application extension may be embedded in an operating system for the electronic device.

In one embodiment, the profile identifier may be associated with a customer.

According to another embodiment, a method for determining card availability may include: (1) determining, by an electronic wallet application executed by a mobile electronic device for a customer, that a financial institution mobile application is installed on the mobile electronic device; (2) accessing, by the electronic wallet application, the financial institution mobile application with a customer identifier stored on the mobile electronic device; (3) receiving, by the electronic wallet application and using the financial institution mobile application, an indication that there are eligible financial accounts for the customer that are eligible for provisioning to the electronic wallet application; (4) displaying, by the electronic wallet application and on a display of the mobile electronic device, a provisioning icon; (5) receiving, by the electronic wallet application, a selection of the provisioning icon; (6) presenting, by the electronic wallet application, an authentication window for a financial institution backend on the display of the electronic device, wherein the authentication window is configured to receive authentication credentials from a user; (7) establishing, by electronic wallet application, a secure session with the financial institution backend; (8) receiving, by electronic wallet application, a list of identifiers for one or more eligible accounts for provisioning; (9) displaying, by the electronic wallet application, the list of identifiers; (10) receiving, by the electronic wallet application, a selection of one of the one or more eligible accounts for provisioning; (11) providing, by the electronic wallet application, an identifier for the selected eligible account to the financial institution backend, (12) receiving, by the electronic wallet application, a provisioning payload for the selected eligible account from the financial institution backend; and (13) initiating, by the electronic wallet application, in-application provisioning for the selected account using the provisioning payload.

In one embodiment, the electronic wallet application may determine that the financial institution mobile application is installed on the mobile electronic device using an Application Programming Interface (API) provided by an operating system of the mobile electronic device.

In one embodiment, the electronic wallet application may also receive a pointer for each eligible account in the list of identifiers.

In one embodiment, the customer identifier may include a cookie, a token, etc.

In one embodiment, an oAuth token may be associated with the secure session, and the electronic wallet application may return the oAuth token to the financial institution backend with the identifier for the selected eligible account.

According to another embodiment, an electronic device may include a memory comprising an electronic wallet application, an issuing financial institution application, and a profile identifier for a customer; a computer processor executes the electronic wallet application and the issuing financial institution application; and a display. The electronic wallet application may retrieve the profile identifier, may call an issuing financial institution with the profile identifier for a number of eligible payment cards associated with the profile identifier, may receive the number of eligible payment cards associated with the profile identifier from the issuing financial institution; may call a provider for the electronic wallet application for a number of eligible payment cards that are already provisioned to the electronic wallet application; may receive the number of eligible payment cards that are already provisioned to the electronic wallet application; may determine that the number of eligible payment cards is greater than the number of eligible payment cards that are already provisioned to the electronic wallet application; and may cause the display to display an icon indicating an option to add a payment card to a payment card to the electronic wallet application.

In one embodiment, the profile identifier may be encrypted.

In one embodiment, the call to the issuing financial institution may include a call to a database of profile identifiers, each profile identifier mapped to a number of eligible payment cards. The database may be provided at an edge of network for the issuing financial institution.

In one embodiment, the memory may also include an application extension for an issuing financial institution application that extends functionality of the issuing financial institution application to the electronic wallet application, and the electronic wallet application may use the application extension to retrieve the profile identifier from a memory of the electronic device and to call the issuing financial institution with the profile identifier for the number of eligible payment cards associated with the profile identifier

In one embodiment, the application extension may be embedded in an operating system for the electronic device.

In one embodiment, the profile identifier may be associated with a customer.

### BRIEF DESCRIPTION OF THE DRAWINGS

In order to facilitate a fuller understanding of the present invention, reference is now made to the attached drawings in which:

FIG. 1 discloses a system for determining payment card provisioning availability according to one embodiment;

FIGS. 2 and 3 depict a method for determining payment card provisioning availability according to one embodiment;

FIG. 4 depicts a method for determining payment card provisioning availability according to another embodiment;

FIG. 5 depicts a method for determining payment card provisioning availability according to another embodiment;

FIG. 6 depicts a method for determining payment card provisioning availability according to another embodiment;

FIG. 7 depicts a system for determining payment card provisioning availability using card availability application extensions according to an embodiment; and

FIG. 8 depicts a method for determining payment card provisioning availability using card availability application extensions according to an embodiment.

### DETAILED DESCRIPTION OF PREFERRED EMBODIMENTS

Systems and methods for determining payment card provisioning availability in mobile applications are disclosed.

In general, application extensions may be used to extend custom functionality and content beyond a specific mobile application and make the specific mobile application available to users when they are interacting with other applications, the operating system, etc. For example, application extensions may pull user context from the related application via shared cookies and/or key chain capabilities provided by the operating system. The operating system may also provide the protocols and call back APIs to communicate between the operating system and the application extensions.

In embodiments, a user may interact with, or log into, a first mobile application that is trying to be detected by a second mobile application (or the operating system of an electronic device) to obtain data that may be used to influence how the second mobile application (and other applications) surface the existence of the first mobile application. Once detected, the second mobile application or operating system may change its behavior based on the data being exposed by the first mobile application. For example, a second mobile application may change its user interface to support more complex interactions with specific accounts or other data the first mobile application exposes.

In embodiments, the first mobile application may share data by using a custom URL or similar function that may alert the operating system or second application that not only is the first mobile application present, but also has the correct state to be accessed. This state could be driven by the types of accounts or the status of those accounts or some other combination of data that the host system for the first mobile application maintains.

The first mobile application may receive a unique id or other suitable indicator from the operating system or second mobile application that may then be used to share this information either directly on the device or via a secure server to server communication pattern.

If the first mobile application does not have the proper state, the second mobile application or operating system may either suppress the functionality or change the functionality in a way as to encourage the user of the first mobile application to make the required account or setting changes to ensure proper linking.

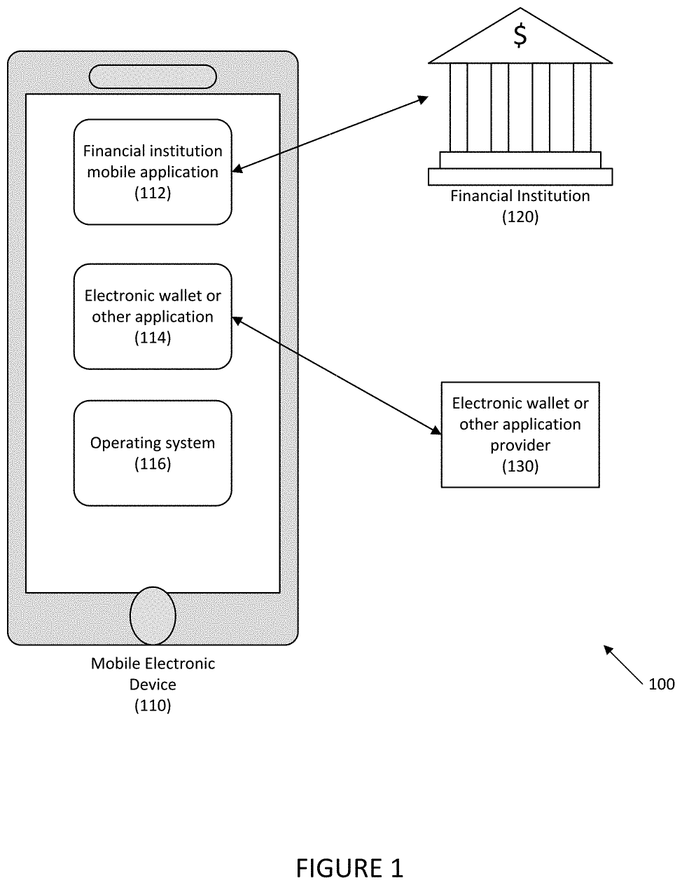

Referring to FIG. 1, a system for determining payment card provisioning availability is disclosed according to one embodiment. System 100 may include mobile electronic device 110, which may be any suitable electronic device that may execute computer programs or applications, including computers, smartphones, smart devices, smart watches, Internet of Things (“IoT”) appliances, etc.

Mobile electronic device 110 may execute one or more computer program, including financial institution mobile application 112 that may be associated with financial institution 120, and electronic wallet or other application 114 that may be associated with electronic wallet or other application provider 130. Mobile electronic device 110 may also execute operating system 116, and other computer programs and applications, such as web browsers and the like (not shown).

Financial institution 120 may be, for example, an issuer of financial instruments, such as credit cards, debit cards, DDA/ACH accounts, Zelle tokens, gift cards, virtual FPAN's, DPAN's, lending accounts, etc.

Financial institution 120 may include a backend (not shown) that may execute one or more computer programs.

In one embodiment, financial institution 120 and electronic wallet or other application provider 130 may be the same, or part of the same organization. In another embodiment, financial institution 120 and electronic wallet or other application provider 130 may be with different organizations.

It should be recognized that although embodiments may be disclosed in the context of electronic wallets and electronic wallet applications, which are mobile applications, any other suitable computer application, mobile application, etc. may be used as is necessary and/or desired.

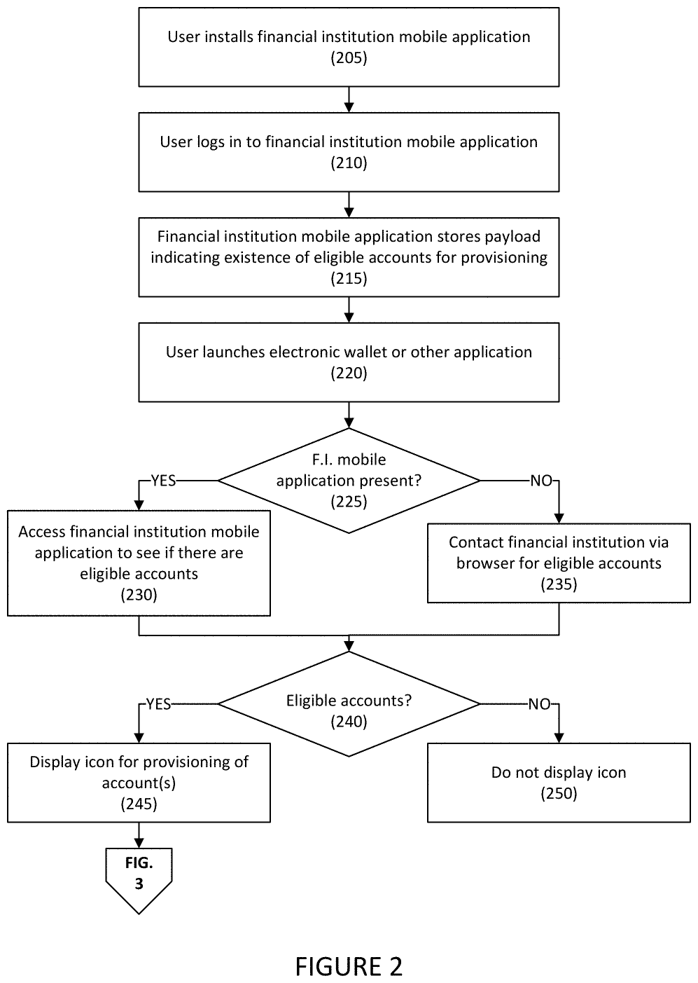

Referring to FIG. 2, a method for determining payment card provisioning availability is disclosed according to one embodiment. In step 205, a user may install a financial institution mobile application on a mobile electronic device, and in step 210, the user may log in to the mobile application in any suitable manner (e.g., username and password, password-less, one time password-based, hardware or software based token generator, public key/private key, biometrics, out of band authentication, etc.).

In step 215, the financial institution mobile application may store a payload on the mobile electronic device that may indicate the existence of one or more financial accounts that may be eligible for provisioning to a mobile application, such as an electronic wallet application. The payload may be stored in a secure location for online or offline use. In one embodiment, the payload may not include any personally-identifiable information (PII). In one embodiment, the financial institution mobile application may update this payload after every user login.

In one embodiment, the payload may include personally identifiable information (PII), that may be encrypted with public key/private key or any other mutually agreed encryption strategy between multiple mobile applications. In the case of public key/private key mechanism, the private key may be exchanged, out of band, and the public key may be hosted on, for example, a public URL.

In step 220, the user may launch an electronic wallet or other application. An example of such an application is ApplePay. Other applications may be used as is necessary and/or desired.

In step 225, the electronic wallet or other application may check to see if the financial institution mobile application is present on the mobile electronic device. In one embodiment, an API provided by the mobile device's operating system may be used to identify the list of applications on the mobile electronic device that support linking. In another embodiment, the operating system may not expose a list of applications, and the electronic wallet or other application may need to identify the financial institution mobile application in the request.

If it is, in step 230, the electronic wallet or other application may access the financial institution mobile application to determine if there are any eligible accounts for provisioning.

If the electronic wallet or other application determines that the financial institution mobile application is not installed, in one embodiment, the process may stop, and no provisioning icon may be presented in the electronic wallet or other application.

In another embodiment, the electronic wallet or other application may retrieve a cookie, a token, etc. on the electronic device that may indicate whether or not there are eligible accounts.

In still another embodiment, in step 235, the electronic wallet may open a browser window and contact the financial institution via an API or other mechanism to determine if there are eligible accounts for provisioning. In one embodiment, the electronic wallet or other application may retrieve a cookie or similar identifier on the mobile electronic device from a prior session (e.g., a browser session) with the financial institution, and may provide the cookie to the financial institution to identify the user. The financial institution may use lightweight authentication or similar to return a binary yes or no to the electronic wallet or other application.

In still another embodiment, the financial institution may push the information needed for the electronic wallet periodically (e.g., at a certain defined interval) to avoid any latency. The data on the device may be available via a pull approach (e.g., mobile app calling financial institution) or a push approach (e.g., financial institution sending data to the device).

In step 240, if there are not any eligible accounts, the process may stop, and in step 250, no provisioning icon may be presented in the electronic wallet or other application.

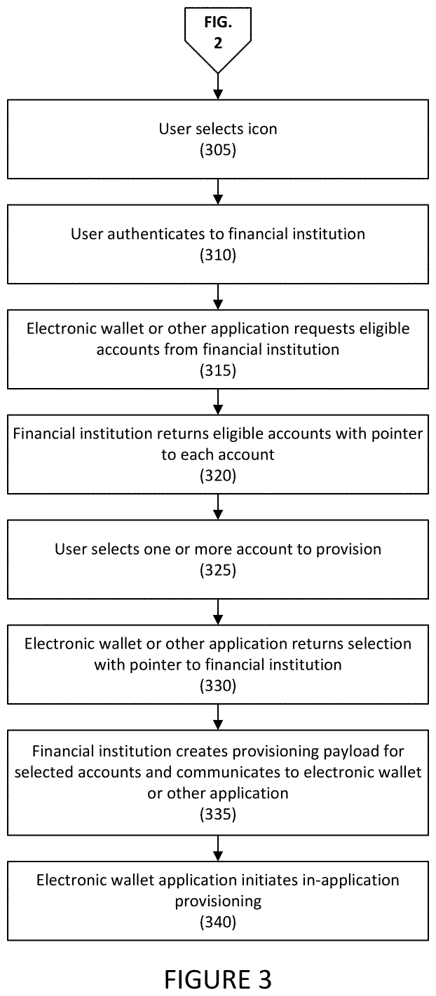

If there are eligible accounts, in step 245, a provisioning icon may be displayed in the electronic wallet or other application. For example, the icon may include a graphic, logo, etc. for the financial institution and instructions to select the icon to provision an account that the user has with the financial institution to the electronic wallet or other application. The process may continue with step 305 in FIG. 3.

In step 305, the user may select the icon, and in step 310, the user may authenticate to the financial institution. In one embodiment, a lightbox or similar may be presented in the electronic wallet or other application, and the user may provide authentication credentials, such as login credentials, to the financial institution. In another embodiment, the electronic wallet or other application may launch a browser window and navigate to the financial institution for the user to enter the authentication credentials.

The electronic wallet or other application, the financial institution, and the electronic device may then establish a secure session using, for example, an OAuth token.

In step 315, using the OAuth token, the electronic wallet or other application may request the one or more eligible accounts from the financial institution. In one embodiment, the electronic wallet or other application may use an exposed API.

In step 320, the financial institution may return a list of eligible accounts to the electronic wallet or other application. In one embodiment the financial institution may return, for example, card art, the last four digits, and a pointer for each account, and may not provide actual account information.

In one embodiment, the financial institution may map each account pointer to one of the eligible accounts.

In step 325, the electronic wallet or other application may display the eligible accounts for the user, and the user may select one or more eligible accounts to provision.

In step 330, the electronic wallet or other application may return the selected account(s) and the account pointer(s) with the OAuth token to the financial institution. In one embodiment, the electronic wallet or other application may use an exposed API.

In step 335, the financial institution may create a provisioning payload for the selected account(s). The financial institution may then communicate the provisioning payload to the electronic wallet or other application.

In step 340, the electronic wallet or other application may initiate in-application provisioning using the provisioning payload.

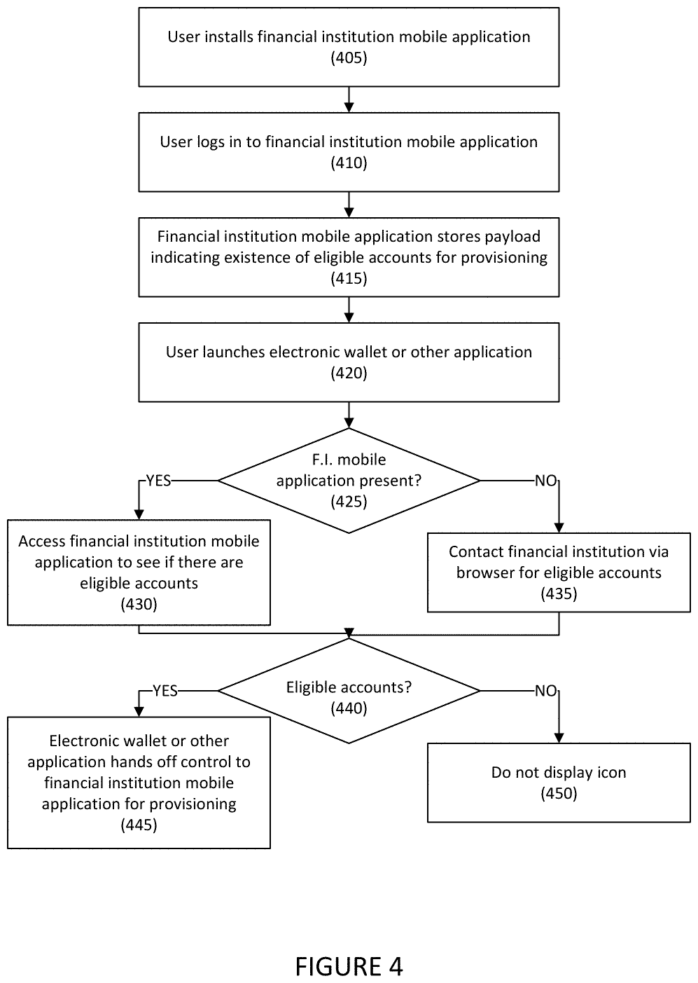

Referring to FIG. 4, a method for determining payment card provisioning availability is disclosed according to one embodiment.

In step 405, a user may install a financial institution mobile application on a mobile electronic device, and in step 410, the user may log in to the mobile application in any suitable manner (e.g., username and password, password-less, one time password-based, hardware or software based token generator, public key/private key, biometrics, out of band authentication, etc.).

In step 415, the financial institution mobile application may store a payload on the mobile electronic device that may indicate the existence of one or more financial accounts that may be eligible for provisioning to a mobile application, such as an electronic wallet application. The payload may be stored in a secure location for online or offline use. In one embodiment, the payload may not include any personally-identifiable information (PII). In one embodiment, the financial institution mobile application may update this payload after every user login.

In one embodiment, the payload may include personally identifiable information (PII), that may be encrypted with public key/private key or any other mutually agreed encryption strategy between multiple mobile applications. In the case of public key/private key mechanism, the private key may be exchanged, out of band, and the public key may be hosted on, for example, a public URL.

In step 420, the user may launch an electronic wallet or other application. An example of such an application is ApplePay. Other applications may be used as is necessary and/or desired.

In step 425, the electronic wallet or other application may check to see if the financial institution mobile application is present on the mobile electronic device. In one embodiment, an API provided by the mobile device's operating system may be used to identify the list of applications on the mobile electronic device that support linking. In another embodiment, the operating system may not expose a list of applications, and the electronic wallet or other application may need to identify the financial institution mobile application in the request.

If it is, in step 430, the electronic wallet or other application may access the financial institution mobile application to determine if there are any eligible accounts for provisioning.

If the electronic wallet or other application determines that the financial institution mobile application is not installed, in one embodiment, the process may stop, and no provisioning icon may be presented in the electronic wallet or other application.

In another embodiment, the electronic wallet or other application may retrieve a cookie, a token, etc. on the electronic device that may indicate whether or not there are eligible accounts.

In still another embodiment, in step 435, the electronic wallet may open a browser window and contact the financial institution via an API or other mechanism to determine if there are eligible accounts for provisioning. In one embodiment, the electronic wallet or other application may retrieve a cookie or similar identifier on the mobile electronic device from a prior session (e.g., a browser session) with the financial institution, and may provide the cookie to the financial institution to identify the user. The financial institution may use lightweight authentication or similar to return a binary yes or no to the electronic wallet or other application.

In still another embodiment, the financial institution may push the information needed for the electronic wallet periodically (e.g., at a certain defined interval) to avoid any latency. The data on the device may be available via a pull approach (e.g., mobile app calling financial institution) or a push approach (e.g., financial institution sending data to the device).

In step 440, if there are not any eligible accounts, the process may stop, and in step 450, no provisioning icon may be presented in the electronic wallet or other application.

If there are eligible accounts, in step 445, the electronic wallet or other application may hand off control to the financial institution mobile application to provision the selected account(s) to the electronic wallet or other application.

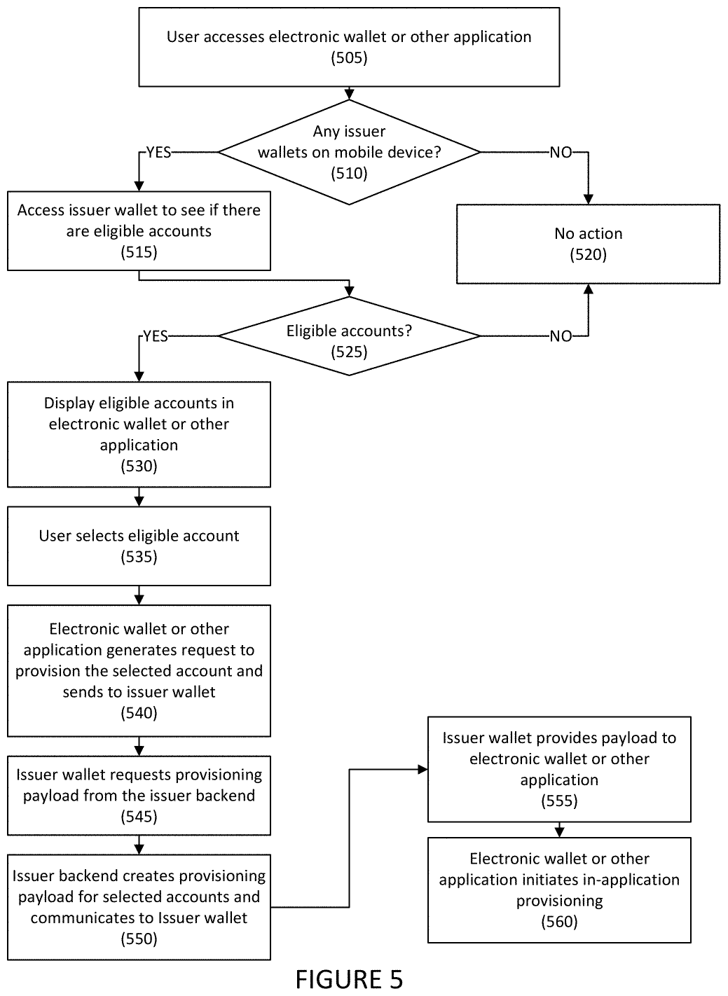

Referring to FIG. 5, a method for determining payment card provisioning availability is provided according to another embodiment.

In step 505, a user may access a mobile application, such as an electronic wallet or other application, on a mobile electronic device. This may be similar to step 220, above.

In step 510, the electronic wallet or other application may determine whether there are any issuer electronic wallet or other applications on the mobile electronic device. This may be similar to step 225, above.

If, in step 515, there are no issuer electronic wallet or other applications on the mobile electronic device, in step 520, the process may stop.

If there is one or more issuer electronic wallet or other application on the mobile electronic device, in step 515, the electronic wallet or other application may access the issuer electronic wallet or other application(s) to identify accounts that are eligible for provisioning to the electronic wallet or other application. In one embodiment, the issuer electronic wallet or other application may return account eligibility to the electronic wallet or other application by, for example, executing eligibility rules, checking with the issuer backend, etc.

If, in step 525, there are no accounts that are eligible for provisioning to the electronic wallet or other application, in step 520, no action is taken.

If, in step 525, there is one or more account that is eligible for provisioning to the electronic wallet or other application, in step 530, the eligible accounts are displayed in the electronic wallet or other application. In one embodiment, an icon and an account identifier (e.g., the issuer, an account nickname, last four digits of the account number, etc.), may be displayed.

In step 535, the user may select an eligible account from the list presented in the electronic wallet or other application.

In step 540, the electronic wallet or other application may generate a request to provision the selected account and may communicate the request to the issuer electronic wallet or other application.

In step 545, the issuer electronic wallet or other application may request a provisioning payload from the issuer backend.

In step 550, the issuer backed may generate a provisioning payload for the selected account and may provide the provisioning payload to the issuer electronic wallet or other application.

In step 555, the issuer electronic wallet or other application may provide the provisioning payload to the electronic wallet or other application, and in step 560, the electronic wallet or other application may initiate in-application provisioning using the provisioning payload.

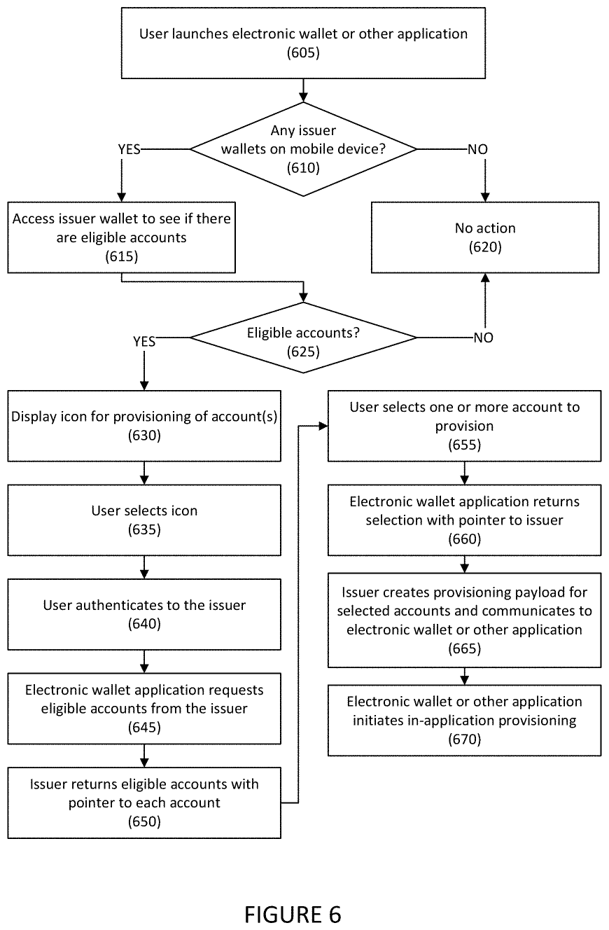

Referring to FIG. 6, a method for determining payment card provisioning availability is disclosed according to another embodiment.

In step 605, a user may access an electronic wallet or other application on a mobile electronic device. This may be similar to step 505, above.

In step 610, the electronic wallet or other application may determine whether there are any issuer electronic wallet or other applications on the mobile electronic device. This may be similar to step 510, above.

If, in step 615, there are no issuer electronic wallet or other applications on the mobile electronic device, in step 620, the process may stop. These steps may be similar to steps 515 and 520, respectively.

If there is one or more issuer electronic wallet or other application on the mobile electronic device, in step 615, the electronic wallet or other application may access the issuer electronic wallet or other application to identify accounts that are eligible for provisioning to the electronic wallet or other application. This may be similar to step 515, above

If, in step 625, there are no accounts that are eligible for provisioning to the electronic wallet or other application, in step 620, no action is taken. These steps may be similar to steps 615 and 620, respectively.

If, in step 625, there is one or more account that is eligible for provisioning to the electronic wallet or other application, in step 630, the eligible accounts are displayed in the electronic wallet or other application. In one embodiment, an icon and an account identifier (e.g., the issuer, an account nickname, last four digits of the account number, etc.), may be displayed. These steps may be similar to steps 625 and 630, respectively.

In step 635, the user may select an eligible account from the list presented in the electronic wallet or other application. This may be similar to step 535, above.

In step 640, the user may authenticate to the issuer. In one embodiment, a lightbox or similar may be presented in the electronic wallet or other application, and the user may provide authentication, or login credentials to the financial institution. In another embodiment, the electronic wallet or other application may launch a browser window and navigate to the issuer for the user to enter the authentication credentials.

The electronic wallet or other application, the issuer, and the electronic device may then establish a secure session using, for example, an OAuth token.

In step 645, using the OAuth token, the electronic wallet or other application may request the one or more eligible accounts from the issuer. In one embodiment, the electronic wallet or other application may use an exposed API.

In step 650, the issuer may return a list of eligible accounts to the electronic wallet or other application. In one embodiment the issuer may return, for example, card art, the last four digits, and a pointer for each account, and may not provide actual account information.

In one embodiment, the issuer may map each account pointer to one of the eligible accounts.

In step 655, the electronic wallet or other application may display the eligible accounts for the user, and the user may select one or more eligible accounts to provision.

In step 660, the electronic wallet or other application may return the selected account(s) and the account pointer(s) with the OAuth token to the issuer. In one embodiment, the electronic wallet or other application may use an exposed API.

In step 665, the issuer may create a provisioning payload for the selected account(s). The issuer may then communicate the provisioning payload to the electronic wallet or other application.

In step 670, the electronic wallet or other application may initiate in-application provisioning using the provisioning payload.

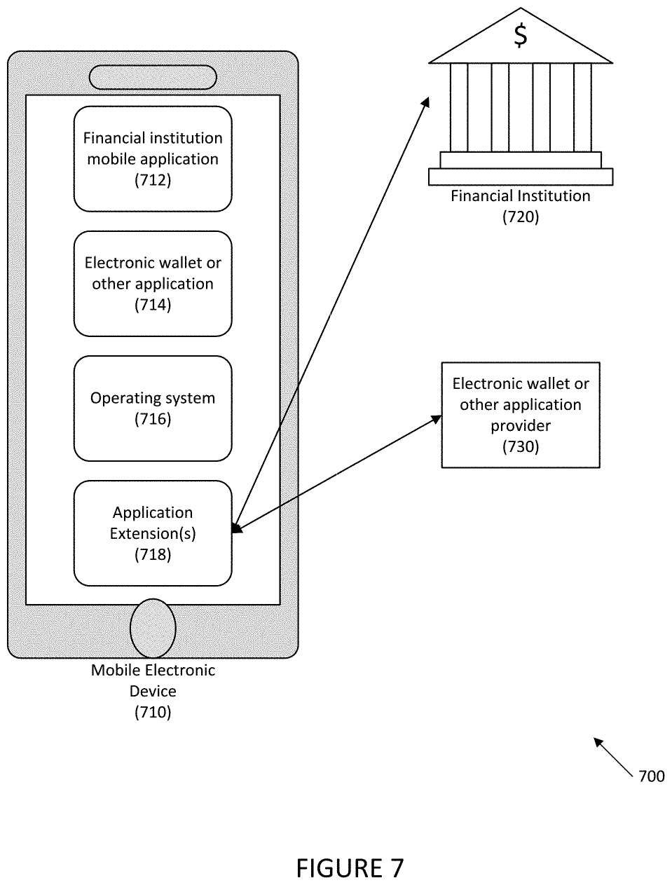

Referring to FIG. 7, a system for determining payment card provisioning availability using card availability application extensions is provided according to an embodiment. For example, in some embodiments above, the availability of eligible accounts for provisioning is determined so that an icon may or may not be presented to the user, thereby enhancing the user experience. In one embodiment, using an application extension for the electronic wallet or other application provided by the issuing financial institution, the electronic wallet or other application, such as Apple Pay, may make two calls. For example, a first call may be made to the issuing financial institution to determine the total number of eligible cards that the customer has. The second call may be to the electronic wallet provider to determine the number of cards from the issuing financial institution that are provisioned to the electronic wallet or other application. By comparing the results of the two calls, a determination as to whether there are any un-provisioned eligible cards can be determined. If there are un-provisioned eligible cards, an “add card” or similar icon may be displayed to the user. If there are no un-provisioned eligible cards, the icon may not be displayed.

This improves the user experience as the user is not going to go through the flow only to find out that there are no eligible cards to add to the electronic wallet or other application.

System 700 may include mobile electronic device 710, which may be any suitable electronic device that may execute computer programs or applications, including computers, smartphones, smart watches, Internet of Things (“IoT”) appliances, etc.

Mobile electronic device 710 may execute one or more computer program, including financial institution mobile application 712 that may be associated with financial institution 720, and electronic wallet or other application 714 that may be associated with electronic wallet or other application provider 730. Mobile electronic device 710 may also execute operating system 716, and other computer programs and applications, such as web browsers and the like (not shown).

Mobile device 710 may further execute one or more application extensions 718 for financial institution mobile application 712. Application extensions 718 may extend the functionality of financial institution mobile application 712 to other applications, such as electronic wallet or other application 714. Application extension(s) 718 may be provided by financial institution 720 and may enable electronic wallet or other application 714 to read a profile identifier for the customer that may be stored on mobile electronic device 710. In one embodiment, the profile identifier may be encrypted.

Application extension(s) 718 may further make calls to financial institution 720 and to electronic wallet or other application provider 730. For example, application extension(s) 718 may call financial institution 720 for the number of eligible cards associated with the profile identifier, and to electronic wallet or other application provider 730 for a number of provisioned eligible cards for the profile identifier.

In another embodiment, application extension(s) 718 may be provided by electronic wallet or other application provider 730 and may extend the functionality of electronic wallet or other application 714 to financial institution mobile application 712 so that financial institution mobile application 712 can look up a number of already provisioned financial instruments from electronic wallet or other application provider 730.

Financial institution 720 may be, for example, an issuer of financial instruments, such as credit cards, debit cards, DDA/ACH accounts, Zelle tokens, gift cards, virtual FPAN's, DPAN's, lending accounts, etc.

In one embodiment, financial institution 720 and electronic wallet or other application provider 730 may be the same, or part of the same organization. In another embodiment, financial institution 720 and electronic wallet or other application provider 730 may be with different organizations.

It should be recognized that although embodiments may be disclosed in the context of electronic wallets and electronic wallet applications, which are mobile applications, any other suitable computer application, mobile application, etc. may be used as is necessary and/or desired.

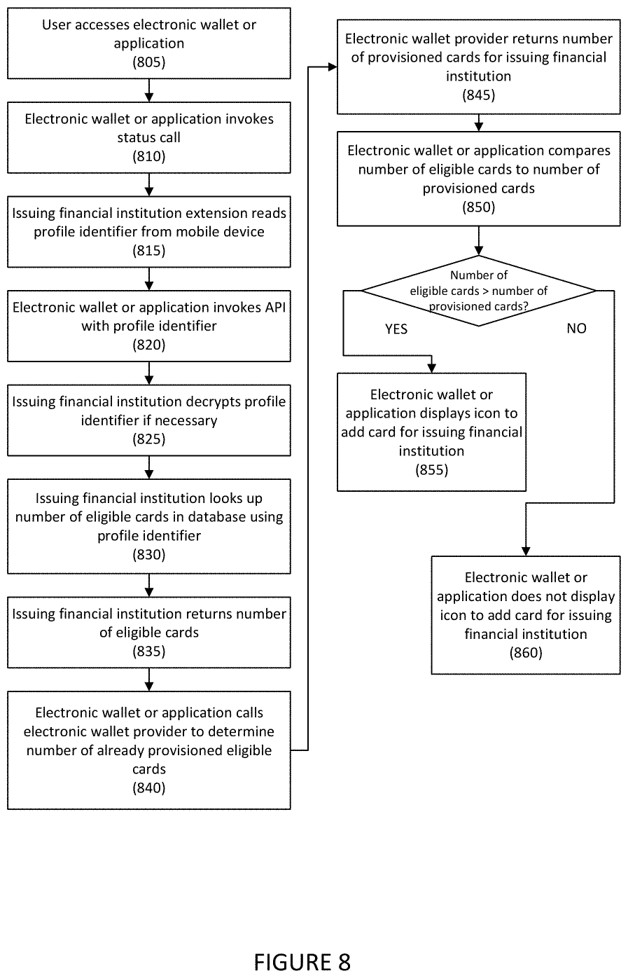

Referring to FIG. 8, a method for determining payment card provisioning availability using card availability application extensions is provided according to an embodiment.

In FIG. 8, in step 805, a user may access an electronic wallet or application on an electronic device, and, in step 810, the electronic wallet or other application may invoke a status call. In one embodiment, the electronic wallet or other application may use an application extension for the financial institution mobile application that may be provided by the issuing financial institution.

In step 815, the electronic wallet or other application may read a profile identifier for the customer that may be stored on the mobile electronic device. In one embodiment, the profile identifier may be encrypted. In one embodiment, the electronic wallet or other application may use the application extension.

In step 820, the electronic wallet or other application may make an API call to the issuing financial institution where, if necessary, in step 825, it may be decrypted and, in step 830, may be used to lookup a number of eligible cards associated with the profile identifier. In one embodiment, the electronic wallet or other application may use the application extension.

In one embodiment, the issuing financial institution may provide a database of profile identifiers mapped to a number of eligible cards. The database may be updated periodically or whenever an event that changes the number of cards occurs. For example, the database may be updated whenever a customer has a new card issued, or when a customer cancelled an issued card.

In one embodiment, the database may be provided and updated independently of the call to the issuing financial institution.

In one embodiment, the database may be located on an edge of a network to minimize access time.

In step 835, the issuing financial institution may return the number of eligible cards to the application extension.

In parallel with the first call, or before or after the first call, in step 840, the electronic wallet or other application may make a second call to the electronic wallet or other application provider for the number of already provisioned eligible cards. In step 845, the electronic wallet or other application provider may return the number of already provisioned eligible cards to the electronic wallet or other application.

Once the electronic wallet or other application has the number of eligible cards from the first call, and the number of already provisioned eligible cards from the second call, in step 850, the electronic wallet or other application may determine if there are any un-provisioned eligible cards by comparing the number returned by each call. In one embodiment, the electronic wallet or other application may use the application extension to do this. If the number of eligible cards from the first call is greater than the number of already provisioned eligible cards from the second call, which indicates that there are eligible un-provisioned cards, and in step 855, the electronic wallet or other application may cause an icon for adding a card from the issuing financial institution to be displayed.

If the number of eligible cards from the first call is not greater than to the number of already provisioned eligible cards from the second call, this indicates that there are no eligible un-provisioned cards, and in step 860, the icon may for adding a card from the issuing financial institution may not be displayed.

It should be recognized that in an alternate embodiment, the process may involve the financial institution mobile application using an application extension provided by the electronic wallet or other application provider that extends the functionality of the electronic wallet or other application to the financial institution mobile application. The financial institution mobile application may use the application extension to request the number of already provisioned financial instruments from electronic wallet or other application provider. Using this information, and the number of eligible financial instruments that it may receive from the financial institution backend, the financial institution mobile application may or may not display an icon to push provision an eligible financial instrument to the electronic wallet or other application.

In one embodiment, the process may occur within about 100 ms.

he disclosures of U.S. patent application Ser. No. 17/071,666, filed Oct. 15, 2020, and U.S. Provisional Patent Application Ser. No. 62/916,446 filed Oct. 17, 2019, are hereby incorporated, by reference, in their entireties.

Although several embodiments have been disclosed, these embodiments are not exclusive to each other, and features from one may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for determining card availability, comprising:
retrieving, by an electronic wallet application executed by an electronic device, a profile identifier from a memory of the electronic device;
calling, by the electronic wallet application, an issuing financial institution with the profile identifier for a number of eligible payment cards associated with the profile identifier;
receiving, by the electronic wallet application, the number of eligible payment cards associated with the profile identifier from the issuing financial institution;
calling, by the electronic wallet application, a provider for the electronic wallet application for a number of eligible payment cards that are already provisioned to the electronic wallet application;
receiving, by the electronic wallet application, the number of eligible payment cards that are already provisioned to the electronic wallet application;
determining, by the electronic wallet application, that the number of eligible payment cards is greater than the number of eligible payment cards that are already provisioned to the electronic wallet application; and
displaying, by the electronic wallet application, an icon indicating an option to add a payment card to a payment card to the electronic wallet application.

2. The method of claim 1, wherein the profile identifier is encrypted.

3. The method of claim 1, wherein the call to the issuing financial institution comprises a call to a database of profile identifiers, each profile identifier mapped to a number of eligible payment cards.

4. The method of claim 3, wherein the database is at an edge of network for the issuing financial institution.

5. The method of claim 1, wherein the electronic wallet application uses an application extension for an issuing financial institution application that extends functionality of the issuing financial institution application to the electronic wallet application to retrieve the profile identifier from a memory of the electronic device and to call the issuing financial institution with the profile identifier for the number of eligible payment cards associated with the profile identifier.

6. The method of claim 5, wherein the application extension is embedded in an operating system for the electronic device.

7. The method of claim 1, wherein the profile identifier is associated with a customer.

8. A method for determining card availability, comprising:
determining, by an electronic wallet application executed by a mobile electronic device for a customer, that a financial institution mobile application is installed on the mobile electronic device;
accessing, by the electronic wallet application, the financial institution mobile application with a customer identifier stored on the mobile electronic device;
receiving, by the electronic wallet application and using the financial institution mobile application, an indication that there are eligible financial accounts for the customer that are eligible for provisioning to the electronic wallet application;
displaying, by the electronic wallet application and on a display of the mobile electronic device, a provisioning icon;
receiving, by the electronic wallet application, a selection of the provisioning icon;
presenting, by the electronic wallet application, an authentication window for a financial institution backend on the display of the electronic device, wherein the authentication window is configured to receive authentication credentials from a user;
establishing, by electronic wallet application, a secure session with the financial institution backend;
receiving, by electronic wallet application, a list of identifiers for one or more eligible accounts for provisioning;
displaying, by the electronic wallet application, the list of identifiers;
receiving, by the electronic wallet application, a selection of one of the one or more eligible accounts for provisioning;
providing, by the electronic wallet application, an identifier for the selected eligible account to the financial institution backend,
receiving, by the electronic wallet application, a provisioning payload for the selected eligible account from the financial institution backend; and
initiating, by the electronic wallet application, in-application provisioning for the selected account using the provisioning payload.

9. The method of claim 8, wherein the electronic wallet application determines that the financial institution mobile application is installed on the mobile electronic device using an Application Programming Interface (API) provided by an operating system of the mobile electronic device.

10. The method of claim 8, wherein the electronic wallet application further receives a pointer for each eligible account in the list of identifiers.

11. The method of claim 8, wherein the customer identifier comprises a cookie.

12. The method of claim 8, wherein the customer identifier comprises a token.

13. The method of claim 8, wherein an oAuth token is associated with the secure session, and the electronic wallet application returns the oAuth token to the financial institution backend with the identifier for the selected eligible account.

14. An electronic device, comprising:
a memory comprising:
an electronic wallet application;
an issuing financial institution application; and
a profile identifier for a customer;
a computer processor that executes the electronic wallet application and the issuing financial institution application; and
a display;
wherein:
the electronic wallet application retrieves the profile identifier;
the electronic wallet application calls an issuing financial institution with the profile identifier for a number of eligible payment cards associated with the profile identifier;
the electronic wallet application receives the number of eligible payment cards associated with the profile identifier from the issuing financial institution;
the electronic wallet application calls a provider for the electronic wallet application for a number of eligible payment cards that are already provisioned to the electronic wallet application;
the electronic wallet application receives the number of eligible payment cards that are already provisioned to the electronic wallet application;
the electronic wallet application determines that the number of eligible payment cards is greater than the number of eligible payment cards that are already provisioned to the electronic wallet application; and
the electronic wallet application causes the display to display an icon indicating an option to add a payment card to a payment card to the electronic wallet application.

15. The electronic device of claim 14, wherein the profile identifier is encrypted.

16. The electronic device of claim 14, wherein the call to the issuing financial institution comprises a call to a database of profile identifiers, each profile identifier mapped to a number of eligible payment cards.

17. The electronic device of claim 16, wherein the database is at an edge of network for the issuing financial institution.

18. The electronic device of claim 14, wherein the memory further comprises an application extension for an issuing financial institution application that extends functionality of the issuing financial institution application to the electronic wallet application, and the electronic wallet application uses the application extension to retrieve the profile identifier from a memory of the electronic device and to call the issuing financial institution with the profile identifier for the number of eligible payment cards associated with the profile identifier.

19. The electronic device of claim 18, wherein the application extension is embedded in an operating system for the electronic device.

20. The electronic device of claim 14, wherein the profile identifier is associated with a customer.
